(19) United States
(12) Patent Application Publication
(10) Pub. No.: US 2017/0091130 A1
(43) Pub. Date: Mar. 30, 2017

(54) BUS SYSTEM

(71) Applicant: Renesas Electronics Corporation, Tokyo (JP)

(72) Inventor: Toshiyuki MATSUNAGA, Tokyo (JP)

(21) Appl. No.: 15/217,982

(22) Filed: Jul. 23, 2016

(30) Foreign Application Priority Data
Sep. 28, 2015 (JP) 2015-189795

(51) Int. Cl. G06F 13/364; G06F 13/42

(52) U.S. Cl. CPC G06F 13/364; G06F 13/4282

(57) ABSTRACT

When a first dummy master device receives a signal indicating that valid data is present, in place of a first master device, the first dummy master device outputs a signal indicating that signal reception is possible. A selector is configured to connect one of the first master device and the first dummy master device to a bus. A system controller is configured to cause only a master device to which a failure occurs to be reset, among a plurality of master devices. A selector control circuit is configured to control the selector to connect the first dummy master device to the bus when the first master device is in a failure state.

This nonprovisional application is based on Japanese Patent Application No. 2015-189795 filed on Sep. 28, 2015 with the Japan Patent Office, the entire contents of which are hereby incorporated by reference.

### BACKGROUND OF THE INVENTION

Field of the Invention

The present invention relates to a bus system.

Description of the Background Art

A method has been known that resets, when a failure occurs to some of devices which constitute a bus system, only the devices to which the failure occurs, rather than resets the whole bus system (see Japanese Patent Laying-Open No. 10-247185 for example).

### SUMMARY OF THE INVENTION

However, even when a device A to which a failure has not occurred outputs a signal to a device B to which a failure has occurred, the device B to which the failure has occurred cannot return a response, since the device B to which the failure has occurred is performing a reset process. Therefore, the device A continues waiting for the response or repeats output of the same signal. As a result, processing of the whole system stagnates.

Other problems and new features will be clear from the description of the present specification and the accompanying drawings.

A bus system of one embodiment includes a first dummy master device connectable to a bus. When the first dummy master device receives a signal indicating that valid data is present, in place of a first master device, the first dummy master device outputs a signal indicating that signal reception is possible. This bus system further includes a selector and a system controller. The selector is configured to connect one of the first master device and the first dummy master device to the bus. The system controller is configured to cause a reset process to be performed by only a master device which is included in a plurality of master devices and to which a failure occurs, so as to cause the master device to which the failure occurs to return to a normal state. This bus system further includes a selector control circuit. The selector control circuit is configured to control the selector to connect the first dummy master device to the bus when the first master device is in a failure state.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of a bus system in a first embodiment.

FIG. 2 is a diagram showing a configuration of a bus system in a second embodiment.

FIG. 3 is a diagram showing a configuration of a bus system in a third embodiment.

FIG. 4 is a diagram for illustrating a system status register.

FIG. 5 is a flowchart showing a process procedure of a master device.

FIG. 6 is a flowchart showing a process procedure of a slave device.

FIG. 7 is a flowchart showing a procedure of a transmission process and a reception process of a master device.

FIG. 8 is a flowchart showing a procedure of a transmission process and a reception process of a slave device.

FIG. 9 is a flowchart showing a procedure of a transmission process and a reception process of a dummy master device.

FIG. 10 is a flowchart showing a procedure of a transmission process and a reception process of a dummy slave device.

FIG. 11 is a diagram for illustrating a first operation example of the bus system in the third embodiment.

FIG. 12 is a diagram for illustrating the first operation example of the bus system in the third embodiment.

FIG. 13 is a diagram for illustrating a second operation example of the bus system in the third embodiment.

FIG. 14 is a diagram for illustrating the second operation example of the bus system in the third embodiment.

FIG. 15 is a diagram for illustrating a conventional operation example.

FIG. 16 is a diagram for illustrating a third operation example of the bus system in the third embodiment.

FIG. 17 is a diagram showing a configuration of a bus system in a fourth embodiment.

FIG. 18 is a diagram showing a configuration of a bus system in a fifth embodiment.

FIG. 19 is a flowchart showing an operational procedure of a master device in a degenerate mode.

### DESCRIPTION OF THE PREFERRED EMBODIMENTS

Hereinafter, embodiments of the present invention will be described by means of the drawings.

### First Embodiment

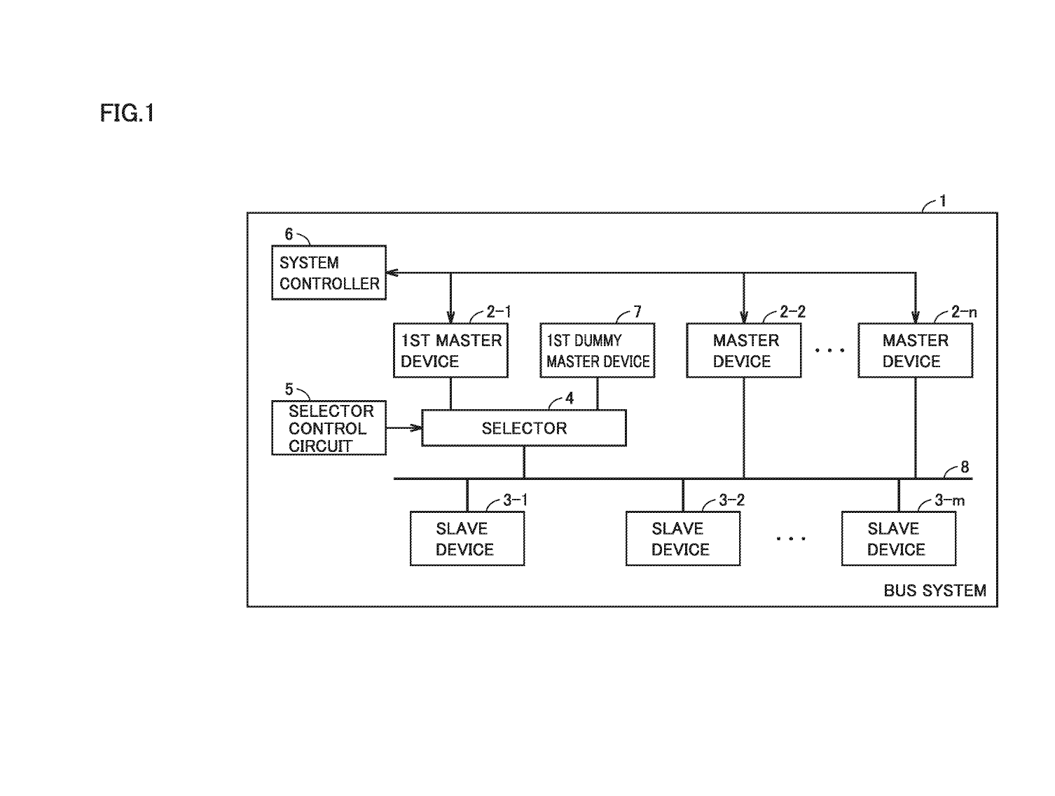

FIG. 1 is a diagram showing a configuration of a bus system 1 in a first embodiment.

This bus system 1 includes a bus 8, a system controller 6, master devices 2-1 to 2-n, slave devices 3-1 to 3-m, a first dummy master device 7, a selector 4, and a selector control circuit 5. It should be noted that n is two or more and m is one or more. One of master devices 2-1 to 2-n is a first master device 2-1.

Master devices 2-1 to 2-n and slave devices 3-1 to 3-m are connectable to bus 8.

System controller 6 is configured to cause a reset process to be performed by only a master device which is one of master devices 2-1 to 2-n and to which a failure occurs. Thus, only the device to which the failure occurs is returned to a normal state. The reset process of a device means that the device is forced to be restarted.

First dummy master device 7 is connectable to bus 8. When first dummy master device 7 receives, in place of first master device 2-1, a signal indicating that valid data is present, first dummy master device 7 outputs a signal indicating that signal reception is possible.

Selector 4 is configured to connect one of first master device 2-1 and first dummy master device 7 to bus 8.

Selector control circuit 5 is configured to control selector 4 to connect first dummy master device 7 to bus 8 when first master device 2-1 is in a failure state.

When a failure occurs to first master device 2-1, the following is performed.

Only the first master device 2-1 is reset. Simultaneously, first dummy master device 7 is connected to bus 8. When first dummy master device 7 receives, in place of first master device 2-1, a signal indicating that valid data is present, first dummy master device 7 outputs a signal indicating that signal reception is possible.

Thus, after any slave device among the slave devices transmits the signal indicating that valid data is present, to first master device 2-1 to which the failure occurs, the slave device can receive the signal indicating that signal reception is possible. As a result, processing of the whole system is prevented from stagnating.

### Second Embodiment

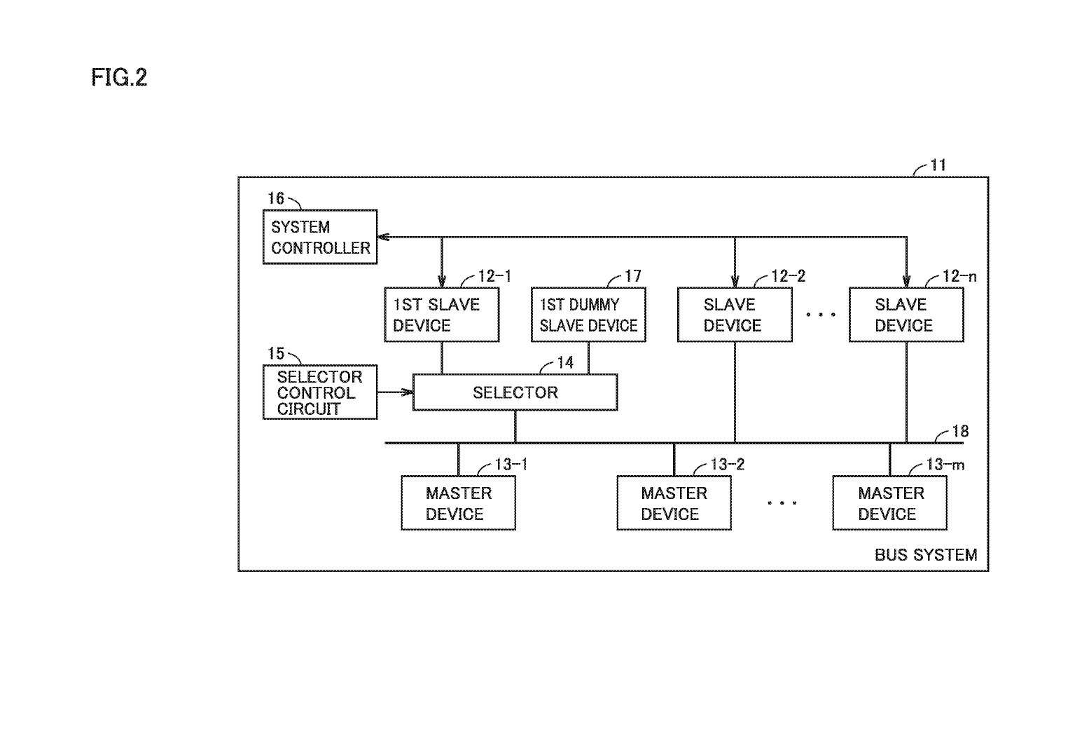

FIG. 2 is a diagram showing a configuration of a bus system 11 in a second embodiment.

This bus system 11 includes a bus 18, a system controller 16, slave devices 12-1 to 12-n, and master devices 13-1 to 13-m. Bus system 11 further includes a first dummy slave device 17, a selector 14, and a selector control circuit 15. It should be noted that n is two or more and m is one or more. One of slave devices 12-1 to 12-n is a first slave device 12-1.

Master devices 13-1 to 13-m and slave devices 12-1 to 12-n are connectable to bus 18.

System controller 16 is configured to cause a reset process to be performed by only a slave device which is one of slave devices 12-1 to 12-n and to which a failure occurs to thereby cause only the slave device to which the failure occurs to return to a normal state. The reset process of a device means that the device is forced to be restarted.

First dummy slave device 17 is connectable to bus 18. When first dummy slave device 17 receives, in place of first slave device 12-1, a signal indicating that valid data is present, first dummy slave device 17 outputs a signal indicating that signal reception is possible.

Selector 14 is configured to connect one of first slave device 12-1 and first dummy slave device 17 to bus 18.

Selector control circuit 15 is configured to control selector 14 to connect first dummy slave device 17 to bus 18 when first slave device 12-1 is in a failure state.

When a failure occurs to first slave device 12-1, the following is performed.

Only the first slave device 12-1 is reset. Simultaneously, first dummy slave device 17 is connected to bus 18. When first dummy slave device 17 receives, in place of first slave device 12-1, a signal indicating that valid data is present, first dummy slave device 17 outputs a signal indicating that signal reception is possible.

Thus, when any master device transmits the signal indicating that valid data is present, to first slave device 12-1 to which the failure occurs, the following is performed. This master device receives, from first dummy slave device 17 corresponding to first slave device 12-1 to which the failure occurs, the signal indicating that signal reception is possible by this first dummy slave device 17. As a result, processing of the whole system is prevented from stagnating.

### Third Embodiment

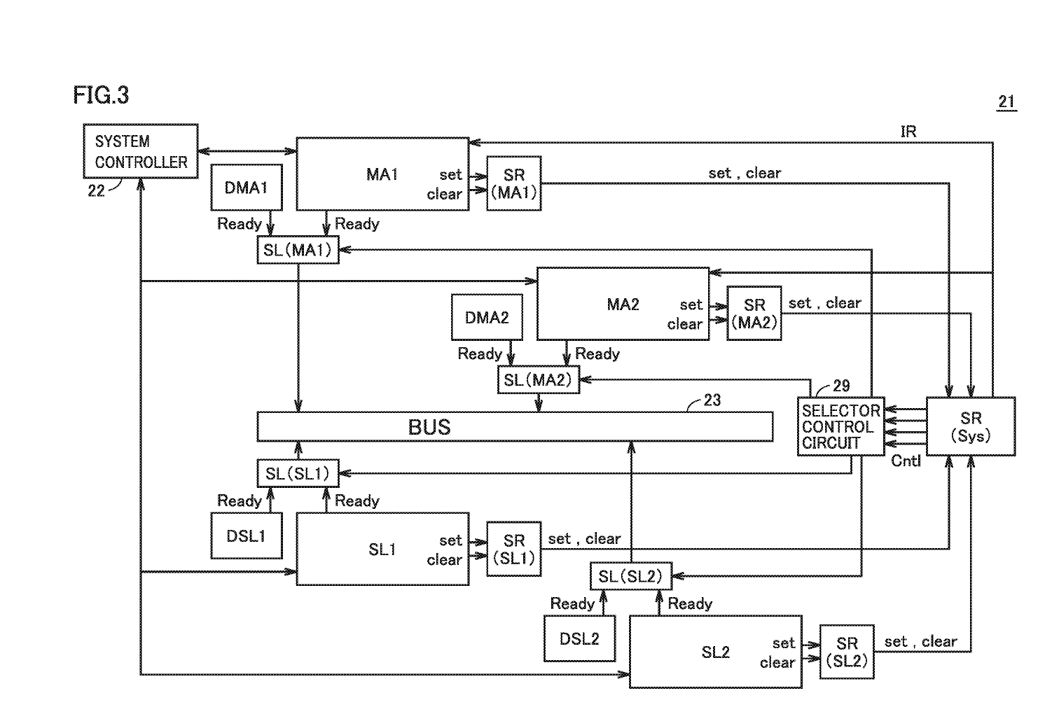

FIG. 3 is a diagram showing a configuration of a bus system 21 in a third embodiment.

This bus system 21 includes master devices MA1, MA2, slave devices SL1, SL2, a bus 23, dummy master devices DMA1, DMA2, and dummy slave devices DSL1, DSL2. This bus system 21 further includes selectors SL (MA1), SL (MA2), SL (SL1), SL (SL2), a system controller 22, and a system status register SR (Sys). This bus system 21 further includes master status registers SR (MA1), SR (MA2), slave status registers SR (SL1), SR (SL2), and a selector control circuit 29.

Master devices MA1, MA2, slave devices SL1, SL2, dummy master devices DMA1, DMA2, and dummy slave devices DSL1, DSL2 are connectable to bus 23.

Bus 23 is used for transmission of a signal to/from master devices MA1, MA2, slave devices SL1, SL2, dummy master devices DMA1, DMA2, and dummy slave devices DSL1, DSL2.

Master devices MA1 and MA2 are each a CPU (Central Processing Unit) or a DMA (Dynamic Memory Access) controller or the like, for example. Slave devices SL1 and SL2 are each a memory controller or an I/O controller or the like, for example. Master devices MA1 and MA2 can operate in accordance with a user program.

Dummy master device DMA1 is provided correspondingly to master device MA1. Dummy master device DMA2 is provided correspondingly to master device MA2. Dummy slave device DSL1 is provided correspondingly to slave device SL1. Dummy slave device DSL2 is provided correspondingly to slave device SL2.

Selector SL (MA1) connects one of master device MA1 and dummy master device DMA1 to bus 23. Selector SL (MA2) connects one of master device MA2 and dummy master device DMA2 to bus 23. Selector SL (SL1) connects one of slave device SL1 and dummy slave device DSL1 to bus 23. Selector SL (SL2) connects one of slave device SL2 and dummy slave device DSL2 to bus 23.

Master status register SR (MA1) is provided correspondingly to master device MA1. Master status register SR (MA1) is a register opened to a user. When a failure occurs to master device MA1, master status register SR (MA1) is set by a hardware component of master device MA1. After master device MA1 is reset, master status register SR (MA1) is cleared by a user program operating on master device MA1.

Master status register SR (MA2) is provided correspondingly to master device MA2. Master status register SR (MA2) is a register opened to a user. When a failure occurs to master device MA2, master status register SR (MA2) is set by a hardware component of master device MA2. After master device MA2 is reset, master status register SR (MA2) is cleared by a user program operating on master device MA2.

Slave status register SR (SL1) is provided correspondingly to slave device SL1. Slave status register SR (SL1) is a register which is not opened to a user. When a failure occurs to slave device SL1, slave status register SR (SL1) is set by a hardware component of slave device SL1. After slave device SL1 is reset, slave status register SR (SL1) is cleared by a hardware component of slave device SL1.

Slave status register SR (SL2) is provided correspondingly to slave device SL2. Slave status register SR (SL2) is a register which is not opened to a user. When a failure occurs to slave device SL2, slave status register SR (SL2) is set by a hardware component of slave device SL2. After slave device SL2 is reset, slave status register SR (SL2) is cleared by a hardware component of slave device SL2.

System status register SR (Sys) is a register for managing whether master devices MA1, MA2 and slave devices SL1, SL2 are each in a normal state or a failure state. System status register SR (Sys) is a register opened to a user. A bit value held in system status register SR (Sys) can be read from master devices MA1, MA2. When the bit value held in system status register SR (Sys) changes, system status register SR (Sys) transmits an interrupt signal IR to master devices MA1, MA2. After receiving the interrupt signal IR, master devices MA1, MA2 can read the bit value of system status register SR (Sys) to identify where a failure occurs or where return to a normal state occurs. Based on an acquired state of each device, master devices MA1, MA2 can change or maintain the mode.

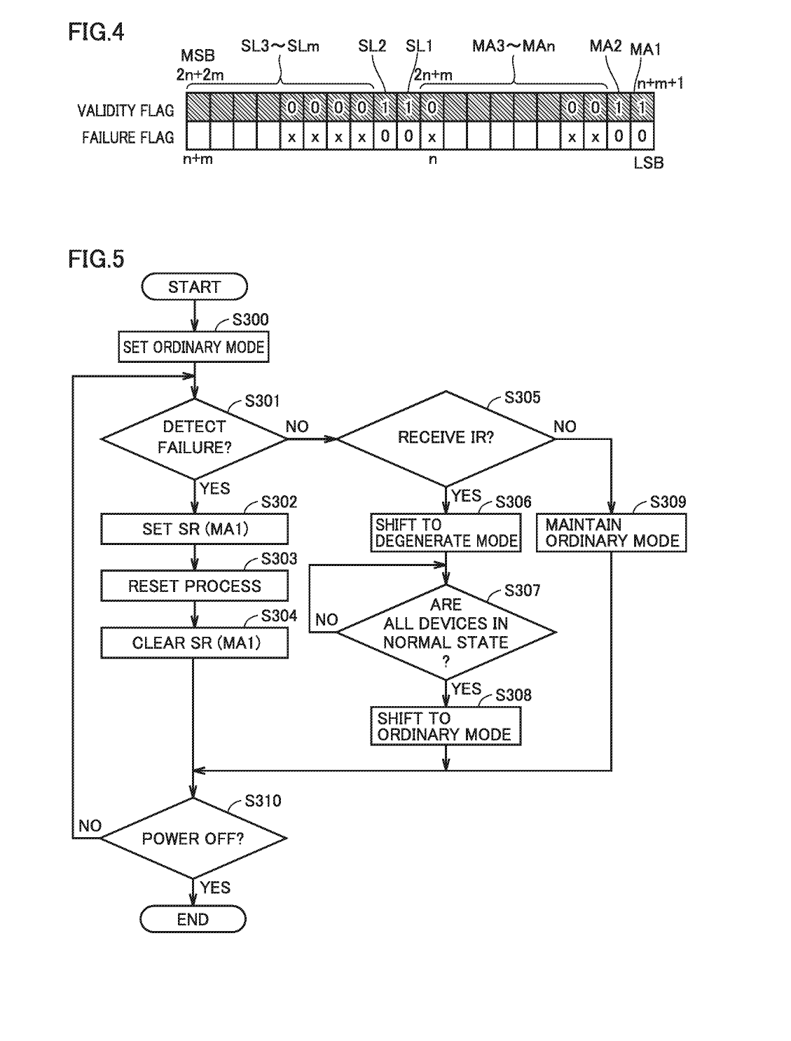

FIG. 4 is a diagram for illustrating system status register SR (Sys).

As shown in FIG. 4, system status register SR (Sys) can hold a plurality of bit values representing whether n master devices and m slave devices are valid/invalid and whether or not they are in a normal state/failure state.

System status register SR (Sys) holds a validity flag corresponding to a master device MAi at a position shifted by i bit(s) from the least significant bit, where i=1 to n. System status register SR (Sys) holds a validity flag corresponding to a slave device SLj at a position shifted by (n+j) bits from the least significant bit, where j=1 to m. System status register SR (Sys) holds a failure flag corresponding to master device MAi at a position shifted by (n+m+i) bits from the least significant bit, where i=1 to n. System status register SR (Sys) holds a failure flag corresponding to slave device SLj at a position shifted by (2n+m+j) bits from the least significant bit, where j=1 to m.

The failure flag corresponding to master device MAi simultaneously corresponds to master status register SR (MAi). The failure flag corresponding to slave device SLj simultaneously corresponds to slave status register SR (SLj).

The fact that the validity flag corresponding to master device MAi (i=1 to n) is “1” indicates that bus system 21 includes master device MAi. The fact that the validity flag corresponding to master device MAi is “0” indicates that bus system 21 does not include master device MAi.

The fact that the validity flag corresponding to slave device SLj (j=1 to m) is “1” indicates that bus system 21 includes slave device SLj. The fact that the validity flag corresponding to slave device SLj is “0” indicates that bus system 21 does not include slave device SLj.

The fact that the failure flag corresponding to master device MAi (i=1 to n) is “0” indicates that master device MAi is in a normal state. The fact that the failure flag corresponding to master device MAi is “1” indicates that master device MAi is in a failure state.

The fact that the failure flag corresponding to slave device SLj (j=1 to m) is “0” indicates that slave device SLj is in a normal state. The fact that the failure flag corresponding to slave device SLj is “1” indicates that slave device SLj is in a failure state.

In the example in FIG. 4, it is indicated that the bus system includes master devices MA1, MA2 and slave devices SL1, SL2. Further, it is indicated that master devices MA1, MA2 and slave devices SL1, SL2 are in a normal state.

After master status register SR (MA1) is set, master status register SR (MA1) sets the bit of the failure flag corresponding to master status register SR (MA1) in system status register SR (Sys). After master status register SR (MA1) is cleared, master status register SR (MA1) clears the bit of the failure flag corresponding to master status register SR (MA1) in system status register SR (Sys).

After master status register SR (MA2) is set, master status register SR (MA2) sets the bit of the failure flag corresponding to master status register SR (MA2) in system status register SR (Sys). After master status register SR (MA2) is cleared, master status register SR (MA2) clears the bit of the failure flag corresponding to master status register SR (MA2) in system status register SR (Sys).

After slave status register SR (SL1) is set, slave status register SR (SL1) sets the bit of the failure flag corresponding to slave status register SR (SL1) in system status register SR (Sys). After slave status register SR (SL1) is cleared, slave status register SR (SL1) clears the bit of the failure flag corresponding to slave status register SR (SL1) in system status register SR (Sys).

After slave status register SR (SL2) is set, slave status register SR (SL2) sets the bit of the failure flag corresponding to slave status register SR (SL2) in system status register SR (Sys). After slave status register SR (SL2) is cleared, slave status register SR (SL2) clears the bit of the failure flag corresponding to slave status register SR (SL2) in system status register SR (Sys).

Based on the bit value of the failure flag in system status register SR (Sys), selector control circuit 29 control switching of selectors SL (MA1), SL (MA2), SL (SL1), SL (SL2).

When the bit value of the failure flag corresponding to master device MA1 is “0”, selector control circuit 29 controls selector SL (MA1) to connect master device MA1 to bus 23. When the bit value of the failure flag corresponding to master device MA1 is “1”, selector control circuit 29 controls selector SL (MA1) to connect dummy master device DMA1 to bus 23.

When the bit value of the failure flag corresponding to master device MA2 is “0”, selector control circuit 29 controls selector SL (MA2) to connect master device MA2 to bus 23. When the bit value of the failure flag corresponding to master device MA2 is “1”, selector control circuit 29 controls selector SL (MA2) to connect dummy master device DMA2 to bus 23.

When the bit value of the failure flag corresponding to slave device SL1 is “0”, selector control circuit 29 controls selector SL (SL1) to connect slave device SL1 to bus 23. When the bit value of the failure flag corresponding to slave device SL1 is “1”, selector control circuit 29 controls selector SL (SL1) to connect dummy slave device DSL1 to bus 23.

When the bit value of the failure flag corresponding to slave device SL2 is “0”, selector control circuit 29 controls selector SL (SL2) to connect slave device SL2 to bus 23. When the bit value of the failure flag corresponding to slave device SL2 is “1”, selector control circuit 29 controls selector SL (SL2) to connect dummy slave device DSL2 to bus 23.

System controller 22 causes only the device to which a failure occurs to perform the reset process, among master devices MA1, MA2 and slave devices SL1, SL2, to thereby cause only the device to which the failure occurs to return to a normal state.

FIG. 5 is a flowchart showing a process procedure of master device MA1. A process procedure of master device MA2 is similar to this.

Referring to FIG. 5, in step S300, master device MA1 shifts the mode to a default ordinary mode. In the ordinary mode, master device MA1 performs its process without being restricted.

When master device MA1 detects occurrence of a failure in step S301, the process proceeds to step S302. When master device MA1 does not detect occurrence of a failure in step S301, the process proceeds to step S305.

In step S302, master device MA1 sets master status register SR (MA1).

In step S303, master device MA1 performs the reset process.

In step S304, master device MA1 clears master status register SR (MA1) after completing the reset process.

When master device MA1 receives the interrupt signal IR from system status register SR (Sys) in step S305, the process proceeds to step S306. When master device MA1 does not receive the interrupt signal IR from system status register SR (Sys) in step S305, the process proceeds to step S309.

In step S306, master device MA1 reads the bit value of system status register SR (Sys) to identify a device to which a failure occurs. Master device MA1 shifts the mode to a degenerate mode appropriate for the device to which the failure occurs.

When the bit value of system status register SR (Sys) which is read by master device MA1 indicates that all devices are normal in step S307, the process proceeds to step S308.

In step S308, master device MA1 shifts the mode to the ordinary mode.

In step S309, master device MA1 maintains the mode in the ordinary mode.

When a power supply for bus system 21 is turned off in step S310 after steps S304, S308, and S309, the process is ended. When the power supply for bus system 21 is ON in step S310, the process returns to step S301.

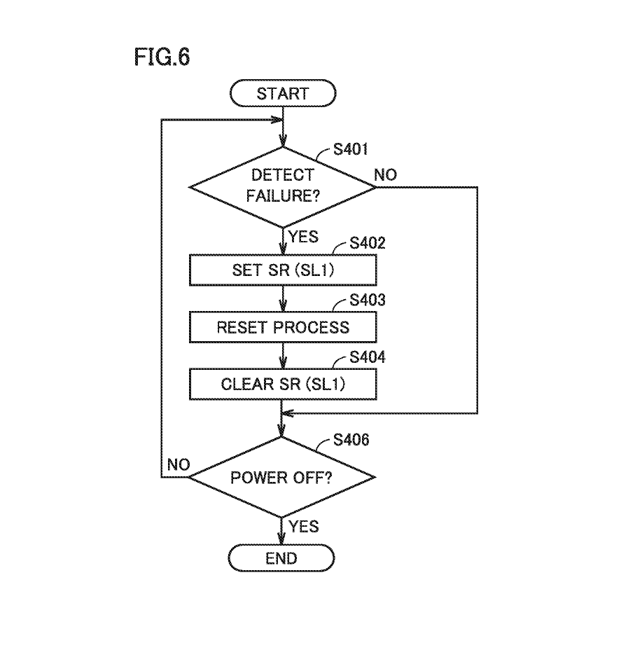

FIG. 6 is a flowchart showing a process procedure of slave device SL1. A process procedure of slave device SL2 is similar to this.

When slave device SL1 detects occurrence of a failure in step S401, the process proceeds to step S402. When slave device SL1 does not detect occurrence of a failure in step S401, the process proceeds to step S406.

In step S402, slave device SL1 sets slave status register SR (SL1).

In step S403, slave device SL1 performs the reset process.

In step S404, slave device SL1 clears slave status register SR (SL1) after completing the reset process.

When the power supply for bus system 21 is turned off in step S406 which is subsequent to step S404 and subsequent to NO in step S401, the process is ended. When the power supply for bus system 21 is ON in step S406, the process returns to step S401.

By handshaking of Valid-Ready between master devices MA1, MA2 and slave devices SL1, SL2, a request is transmitted from master devices MA1, MA2 to slave devices SL1, SL2.

By handshaking of Valid-Ready between master devices MA1, MA2 and slave devices SL1, SL2, a response is transmitted from slave devices SL1, SL2 to master devices MA1, MA2.

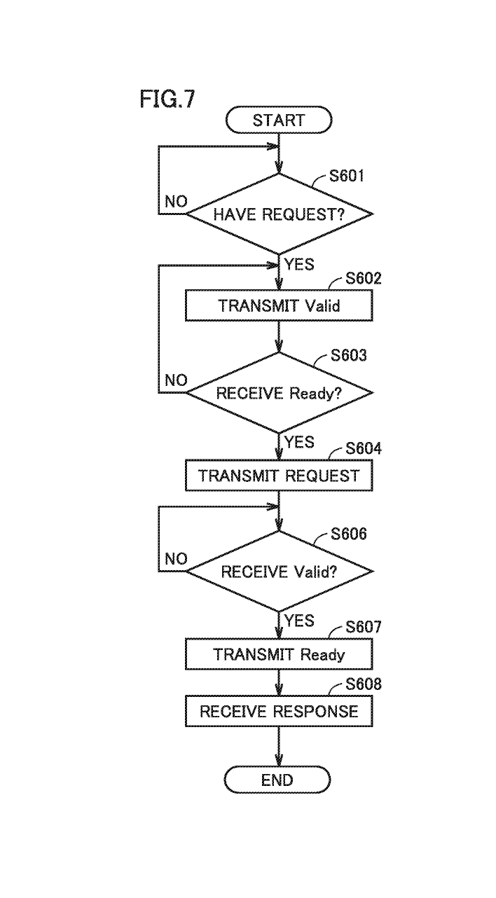

FIG. 7 is a flowchart showing a procedure of a transmission process and a reception process of master device MA1. A procedure of a transmission process and a reception process of master device MA2 is similar to this.

When master device MA1 has a request to be output to slave device SL1 or slave device SL2 in step S601, the process proceeds to step S602. In the following, a slave device which is one of slave device SL1 and slave device SL2 and which is the destination of a request is referred to as slave device SLα.

In step S602, master device MA1 transmits toward slave device SLα a Valid signal indicating that valid data is present. The Valid signal is transmitted to slave device SLα or a dummy slave device DSLα which is an alternative device to slave device SLα.

When master device MA1 receives in step S603 a Ready signal indicating that reception is possible, the process proceeds to step S604. The Ready signal is transmitted from slave device SLα or dummy slave device DSLα. When master device MA1 does not receive in step S603 the Ready signal indicating that reception is possible, the process returns to step S602. Accordingly, master device MA1 re-transmits the Valid signal.

In step S604, master device MA1 transmits the request toward slave device SLα. The request is transmitted to slave device SLα or dummy slave device DSLα.

When master device MA1 receives in step S606 the Valid signal indicating that valid data is present, the process proceeds to step S607. The Valid signal is transmitted from slave device SLα or dummy slave device DSLα.

In step S607, master device MA1 transmits the Ready signal indicating that reception is possible. The Ready signal is transmitted to slave device SLα or dummy slave device DSLα.

In step S608, master device MA1 receives a response. The response is transmitted from slave device SLα or dummy slave device DSLα.

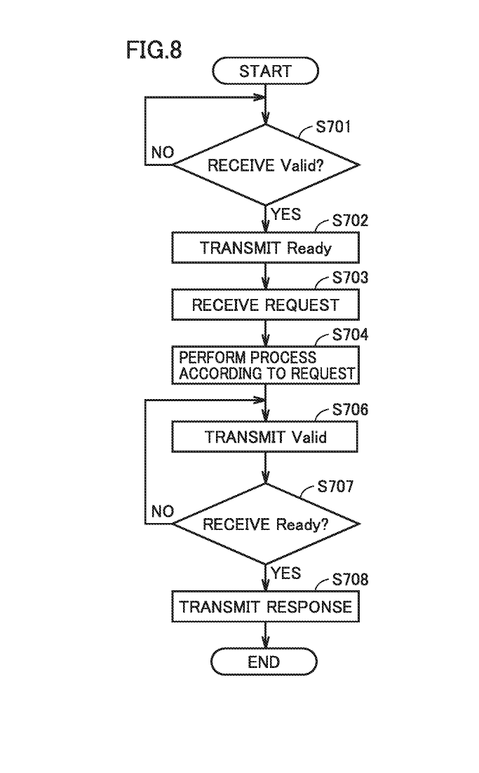

FIG. 8 is a flowchart showing a procedure of a transmission process and a reception process of slave device SL1. A procedure of a transmission process and a reception process of slave device SL2 is similar to this.

When slave device SL1 receives in step S701 the Valid signal indicating that valid data is present, the process proceeds to step S702. In the following, a master device which is one of master device MA1 and master device MA2 and which is a source of a request is referred to as master device MAα. The Valid signal is transmitted from master device MAα or a dummy master device DMAα.

In step S702, slave device SL1 transmits toward master device MAα the Ready signal indicating that reception is possible. The Ready signal is transmitted to master device MAα or dummy master device DMAα.

In step S703, slave device SL1 receives the request. The request is transmitted from master device MAα or dummy master device DMAα.

In step S704, slave device SL1 performs a process according to the request.

In step S706, slave device SL1 transmits toward master device MAα the Valid signal indicating that valid data is present. The Valid signal is transmitted to master device MAα or dummy master device DMAα.

When slave device SL1 receives in step S707 the Ready signal indicating that reception is possible, the process proceeds to step S708. The Ready signal is transmitted from master device MAα or dummy master device DMAα. When slave device SL1 does not receive the Ready signal indicating that reception is possible, the process returns to step S706. Accordingly, slave device SL1 re-transmits the Valid signal.

In step S708, slave device SL1 transmits toward master device MAα a response indicating the result of the process according to the request. The response is transmitted to master device MAα or dummy master device DMAα.

In the case where master device MA1 has outputted in the past the Valid signal to slave device SL1 or SL2, dummy master device DMA1 can receive, in place of master device MA1, the Ready signal which is output from slave device SL1 or SL2. In the case where master device MA1 has outputted in the past a request to slave device SL1 or SL2, dummy master device DMA1 can receive, in place of master device MA1, a response from slave device SL1 or SL2. In place of master device MA1, dummy master device DMA1 can receive the Valid signal which is output from slave device SL1 or SL2, and output the Ready signal. In the case where dummy master device DMA1 outputs the Valid signal to slave device SL1 or SL2, dummy master device DMA1 can receive the Ready signal which is output from slave device SL1 or SL2 in response to the Valid signal. The reason why this function is provided is to prevent such a situation where slave device SL1 or SL 2 repeats output of the Ready signal and the response.

In the case where master device MA2 has outputted in the past the Valid signal to slave device SL1 or SL2, dummy master device DMA2 can receive, in place of master device MA2, the Ready signal which is output from slave device SL1 or SL2 in response to the Valid signal. In the case where master device MA2 has outputted in the past a request to slave device SL1 or SL2, dummy master device DMA2 can receive, in place of master device MA2, a response from slave device SL1 or SL2 that is given in response to the request. In place of master device MA2, dummy master device DMA2 can receive the Valid signal which is output from slave device SL1 or SL2, and output the Ready signal. In the case where dummy master device DMA2 outputs the Valid signal to slave device SL1 or SL2, dummy master device DMA2 can receive the Ready signal which is output from slave device SL1 or SL2 in response to the Valid signal. The reason why this function is provided is to prevent such a situation where slave device SL1 or SL 2 repeats output of the Ready signal and the response.

In place of slave device SL1, dummy slave device DSL1 can receive the Valid signal which is output from master device MA1 or master device MA2, and output the Ready signal to master device MA1 or master device MA2. In the case where slave device SL1 has outputted in the past the Valid signal to master device MA1 or MA2, dummy slave device DSL1 can receive, in place of slave device SL1, the Ready signal which is output from master device MA1 or MA2 in response to the Valid signal. In place of slave device SL1, dummy slave device DSL1 can receive a request which is output from master device MA1 or master device MA2, and output a dummy response to master device MA1 or master device MA2. In the case where dummy slave device DSL1 outputs the Valid signal to master device MA1 or MA2, dummy slave device DSL1 can receive the Ready signal which is output from master device MA1 or MA2. The reason why this function is provided is to prevent such a situation where master device MA1 or MA2 continues waiting for the Ready signal and the response.

In place of slave device SL2, dummy slave device DSL2 can receive the Valid signal which is output from master device MA1 or master device MA2, and output the Ready signal to master device MA1 or master device MA2. In the case where slave device SL2 has outputted in the past the Valid signal to master device MA1 or MA2, dummy slave device DSL2 can receive, in place of slave device SL2, the Ready signal which is output from master device MA1 or MA2 in response to the Valid signal. In place of slave device SL2, dummy slave device DSL2 can receive a request which is output from master device MA1 or master device MA2, and output a dummy response to master device MA1 or master device MA2. In the case where dummy slave device DSL2 outputs the Valid signal to master device MA1 or MA2, dummy slave device DSL2 can receive the Ready signal which is output from master device MA1 or MA2 in response to the Valid signal. The reason why this function is provided is to prevent such a situation where master device MA1 or MA2 continues waiting for the Ready signal and the response.

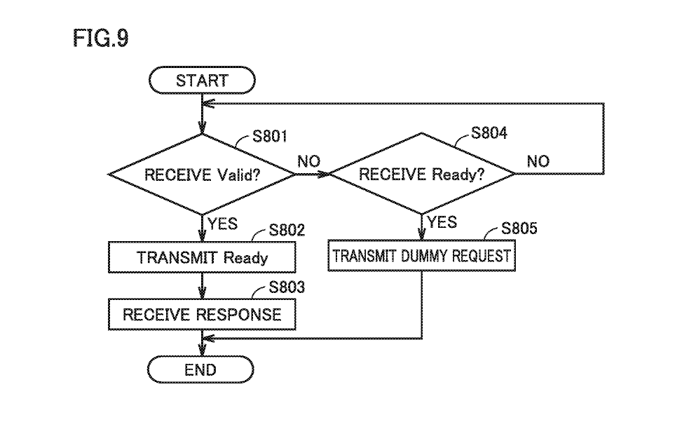

FIG. 9 is a flowchart showing a procedure of a transmission process and a reception process of dummy master device DMA1. A procedure of a transmission process and a reception process of dummy master device DMA2 is similar to this.

When dummy master device DMA1 receives in step S801 the Valid signal indicating that valid data is present, the process proceeds to step S802. In the following, a slave device which is one of slave device SL1 and slave device SL2 and which is the destination of a request is referred to as slave device SLα. The Valid signal is transmitted from slave device SLα or dummy slave device DSLα.

In step S802, dummy master device DMA1 transmits the Ready signal indicating that reception is possible. The Ready signal is transmitted to slave device SLα or dummy slave device DSLα.

In step S803, dummy master device DMA1 receives a response. The response indicates the result of a process by slave device SLα or dummy slave device DSa in response to a request transmitted from master device MA1. The response is transmitted from slave device SLα or dummy slave device DSLα.

When dummy master device DMA1 receives in step S804 the Ready signal indicating that reception is possible, the process proceeds to step S805. The Ready signal is transmitted from slave device SLα or dummy slave device DSLα.

In step S805, dummy master device DMA1 transmits a dummy request toward slave device SLα. The dummy request is transmitted to slave device SLα or dummy slave device DSLα.

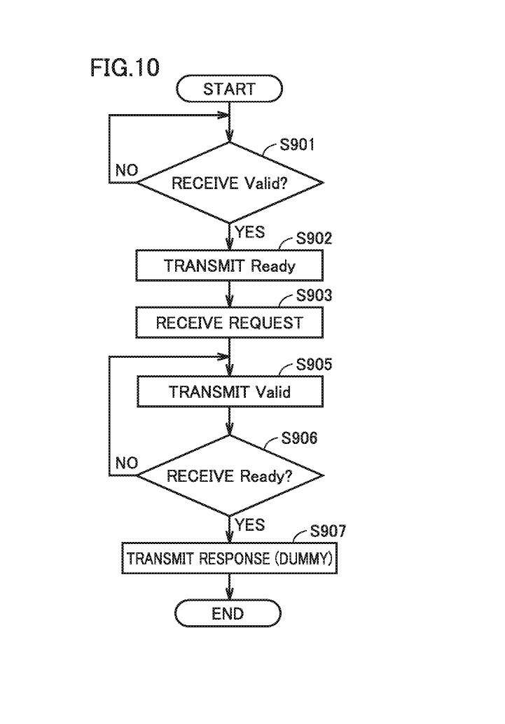

FIG. 10 is a flowchart showing a procedure of a transmission process and a reception process of dummy slave device DSL1. A procedure of a transmission process and a reception process of dummy slave device DSL2 is similar to this.

When dummy slave device DSL1 receives in step S901 the Valid signal indicating that valid data is present, the process proceeds to step S902. In the following, a master device which is one of master device MA1 and master device MA2 and which is the source of a request is referred to as master device MAα. The Valid signal is transmitted from master device MAα or dummy master device DMAα.

In step S902, dummy slave device DSL1 transmits toward master device MAα the Ready signal indicating that reception is possible. The Ready signal is transmitted to master device MAα or dummy master device DMAα.

In step S903, dummy slave device DSL1 receives a request. The request is transmitted from master device MAα or dummy master device DMAα.

In step S905, dummy slave device DSL1 transmits toward master device MAα the Valid signal indicating that valid data is present. The Valid signal is transmitted to master device MAα or dummy master device DMAα.

When dummy slave device DSL1 receives in step S906 the Ready signal indicating that reception is possible, the process proceeds to step S907. The Ready signal is transmitted from master device MAα or dummy master device DMAα. When dummy slave device DSL1 does not receive the Ready signal, the process returns to step S905. Accordingly, dummy slave device DSL1 re-transmits the Valid signal.

In step S907, dummy slave device DSL1 transmits a dummy response toward master device MAα. The response is transmitted to master device MAα or dummy master device DMAα.

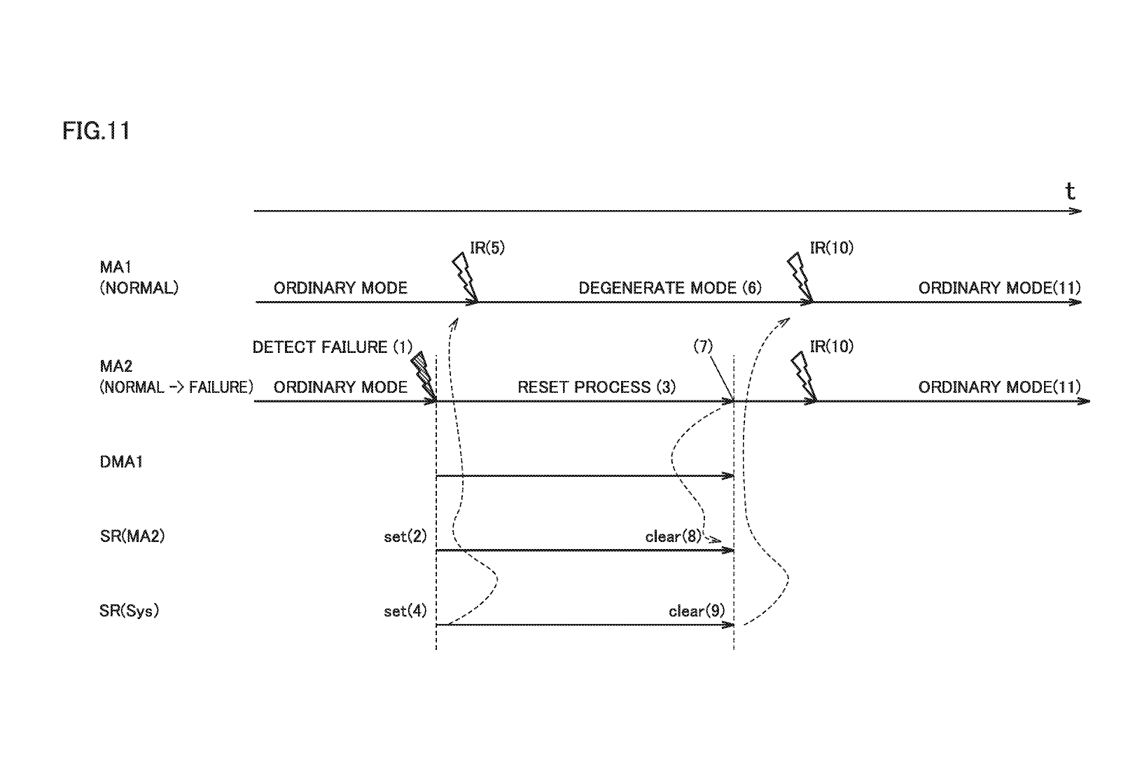

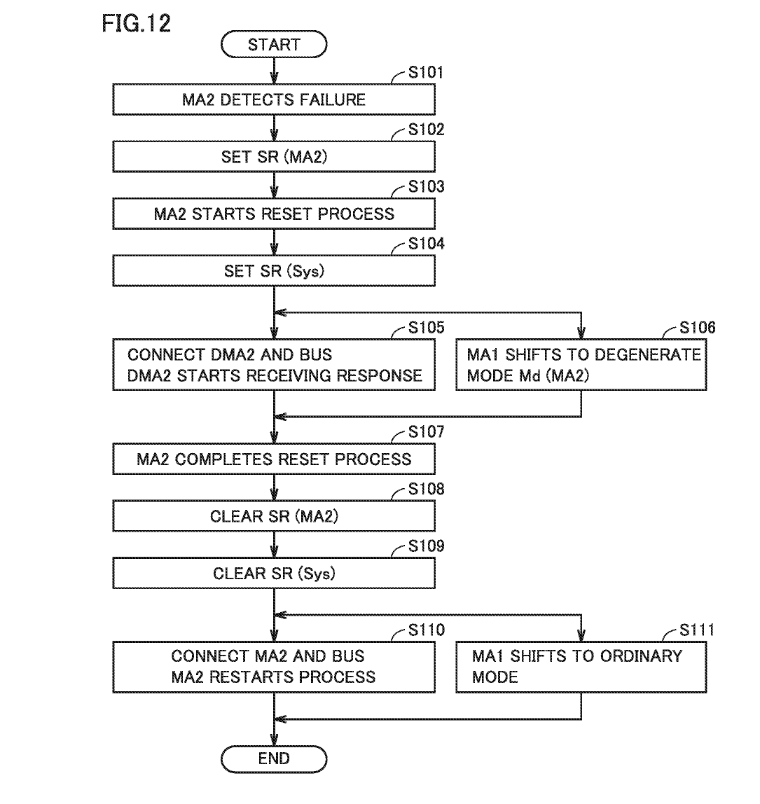

FIGS. 11 and 12 are each a diagram for illustrating a first operation example of bus system 21 in the third embodiment.

In step S101, master device MA2 detects occurrence of a failure (see (1) in FIG. 11).

In step S102, master device MA2 sets master status register SR (MA2) (see (2) in FIG. 11). Accordingly, master status register SR (MA2) holds “1”.

In step S103, master device MA2 starts the reset process (see (3) in FIG. 11).

In step S104, master status register SR (MA2) sets the failure flag corresponding to master device MA2 in system status register SR (Sys) (see (4) in FIG. 11). Accordingly, the failure flag corresponding to master device MA2 in system status register SR (Sys) is set to “1”.

In step S105, in response to the fact that the failure flag corresponding to master device MA2 in system status register SR (Sys) is set to “1”, selector SL (MA2) connects bus 23 and dummy master device DMA2. As a result, dummy master device DMA2 receives, in place of master device MA2, the Valid signal, the Ready signal, and a response from slave device SL1, SL2 or dummy slave device DSL1, DSL2. Dummy master device DMA2 further transmits, in place of master device MA2, the Ready signal and a dummy request to slave device SL1, SL2 or dummy slave device DSL1, DSL2.

In step S106 which is in parallel with step S105, master device MA1 receives the interrupt signal IR from system status register SR (Sys) (see (5) in FIG. 11). After this, master device MA1 reads the failure flag of system status register SR (Sys) to identify master device MA2 as the device to which the failure occurs. Master device MA1 shifts the mode to the degenerate mode Md (MA2) which is a mode while master device MA2 is in the failure state (see (6) in FIG. 11). In the degenerate mode Md (MA2), master device MA1 regulates its process so as not to cause a process for master device MA2. For example, in the case where execution of a certain command A by master device MA1 which has an execution authority causes the execution authority to be delegated to master device MA2, master device MA1 avoids executing command A in the degenerate mode Md (MA2).

In step S107, master device MA2 completes the reset process (see (7) in FIG. 11).

In step S108, master device MA2 clears master status register SR (MA2) (see (8) in FIG. 11). Accordingly, master status register SR (MA2) holds “0”.

In step S109, master status register SR (MA2) clears the failure flag corresponding to master device MA2 in system status register SR (Sys) (see (9) in FIG. 11). Accordingly, the failure flag corresponding to master device MA2 in system status register SR (Sys) is set to “0”.

In step S110, in response to the fact that the failure flag corresponding to master device MA2 in system status register SR (Sys) is set to “0”, selector SL (MA2) connects bus 23 and master device MA2. As a result, master device MA2 receives the Valid signal, the Ready signal, and a response from slave device SL1, SL2 or dummy slave device DSL1, DSL2. Master device MA2 further transmits the Ready signal and a request to slave device SL1, SL2 or dummy slave device DSL1, DSL2.

In step S111 which is in parallel with step S110, master devices MA1 and MA2 receive the interrupt signal IR from system status register SR (Sys) (see (10) in FIG. 11). After this, master devices MA1 and MA2 read all failure flags of system status register SR (Sys) to recognize that all master devices and all slave devices are normal. Accordingly, master devices MA1 and MA2 shift the mode to the ordinary mode (see (11) in FIG. 11).

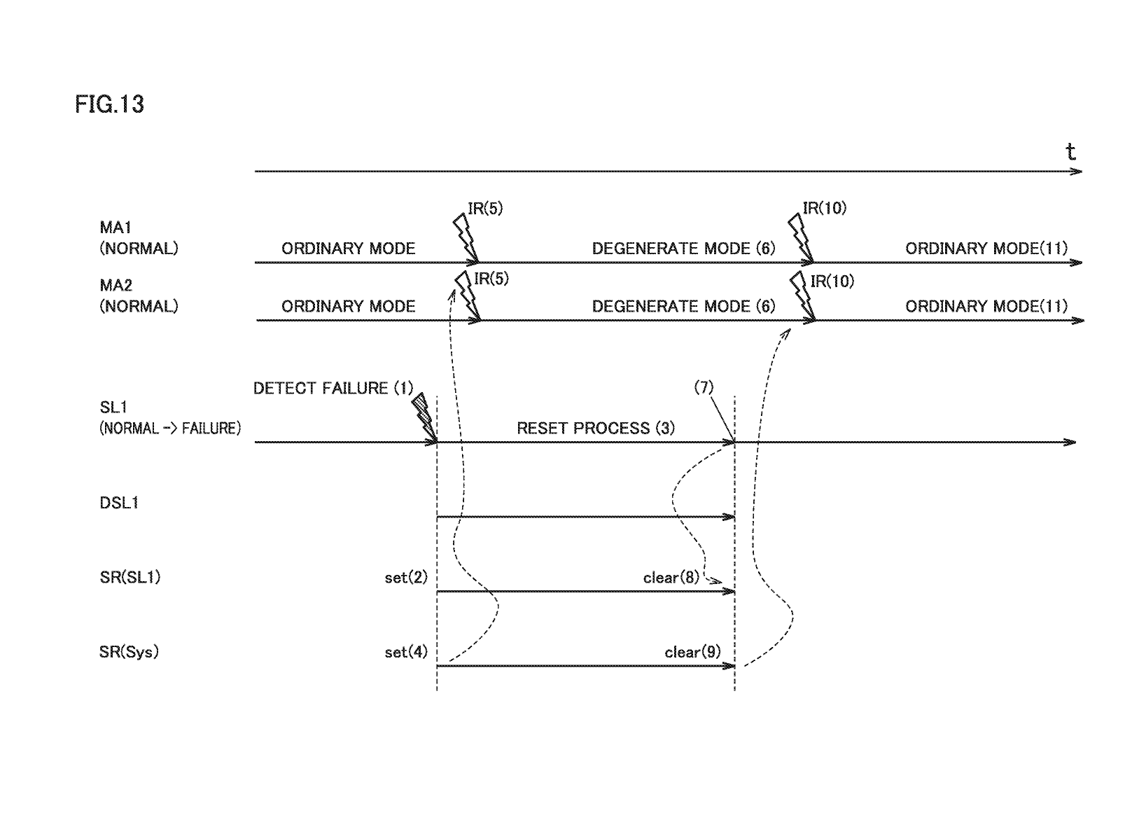

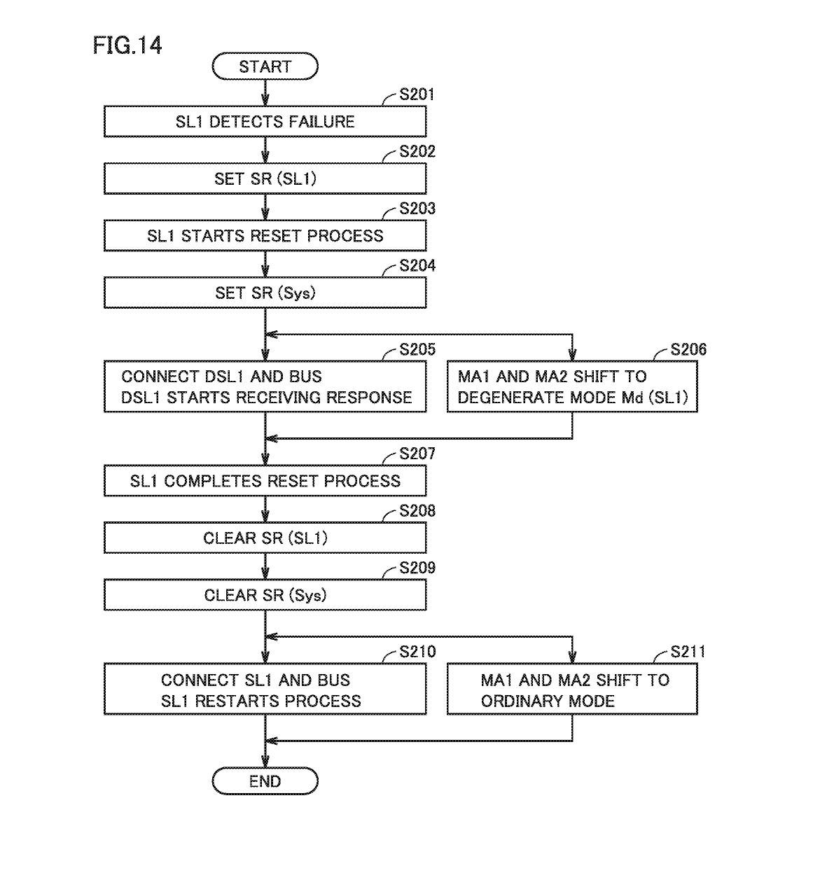

FIGS. 13 and 14 are each a diagram for illustrating a second operation example of bus system 21 in the third embodiment.

In step S201, slave device SL1 detects occurrence of a failure (see (1) in FIG. 13).

In step S202, slave device SL1 sets slave status register SR (SL1) (see (2) in FIG. 13). Accordingly, slave status register SR (SL1) holds “1”.

In step S203, slave device SL1 starts the reset process (see (3) in FIG. 13).

In step S204, slave status register SR (SL1) sets the failure flag corresponding to slave device SL1 in system status register SR (Sys), since slave status register SR (SL1) holds “1” (see (4) in FIG. 13). Accordingly, the failure flag corresponding to slave device SL1 in system status register SR (Sys) is set to “1”.

In step S205, in response to the fact that the failure flag corresponding to slave device SL1 is set to “1” in system status register SR (Sys), selector SL (SL1) connects bus 23 and dummy slave device DSL1. As a result, dummy slave device DSL1 receives, in place of slave device SL1, the Valid signal, the Ready signal, and a request from master device MA1, MA2 or dummy master device DMA1, DMA2. Dummy slave device DSL1 further transmits, in place of slave device SL1, the Ready signal, the Valid signal, and a dummy response to master device MA1, MA2 or dummy master device DMA1, DMA2.

In step S206 which is in parallel with step S205, master device MA1 and master device MA2 receive the interrupt signal IR from system status register SR (Sys) (see (5) in FIG. 13). After this, master device MA1 and master device MA2 read the failure flag of system status register SR (Sys) to identify slave device SL1 as the device to which the failure occurs. Master device MA1 and master device MA2 shift the mode to the degenerate mode Md (SL1) which is a mode while slave device SL1 is in the failure state (see (6) in FIG. 13).

In the degenerate mode Md (SL1), master devices MA1 and MA2 regulate respective processes so as not to cause a process for slave device SL1. For example, master devices MA1 and MA2 do not transmit the signals (request, Ready signal, and Valid signal) toward slave device SL1. In the degenerate mode Md (SL1), master devices MA1 and MA2 ignore a response from dummy slave device DSL1. In the degenerate mode Md (SL1), master devices MA1 and MA2 do not transmit the Ready signal even when they receive the Valid signal from dummy slave device DSL1.

In step S207, slave device SL1 completes the reset process (see (7) in FIG. 13).

In step S208, slave device SL1 clears slave status register SR (SL1) (see (8) in FIG. 13). Accordingly, slave status register SR (SL1) holds “0”.

In step S209, slave status register SR (SL1) clears the failure flag corresponding to slave device SL1 in system status register SR (Sys) (see (9) in FIG. 13), since slave status register SR (SL1) holds “0”. Accordingly, the failure flag corresponding to slave device SL1 in system status register SR (Sys) is set to “0”.

In step S210, in response to the fact that the failure flag corresponding to slave device SL1 in system status register SR (Sys) is set to “0”, selector SL (SL1) connects bus 23 and slave device SL1. As a result, slave device SL1 receives the Valid signal, the Ready signal, and a request from master device MA1, MA2 or dummy master device DMA1, DMA2. Slave device SL1 further transmits the Ready signal, the Valid signal, and a response to master device MA1, MA2 or dummy master device DMA1, DMA2.

In step S211 which is in parallel with step S210, master device MA1 and master device MA2 receive the interrupt signal IR from system status register SR (Sys) (see (10) in FIG. 13). After this, master device MA1 and master device MA2 read the failure flags in system status register SR (Sys) to recognize that all master devices and all slave devices are normal. Accordingly, master device MA1 and master device MA2 shift the mode to the ordinary mode (see (11) in FIG. 13).

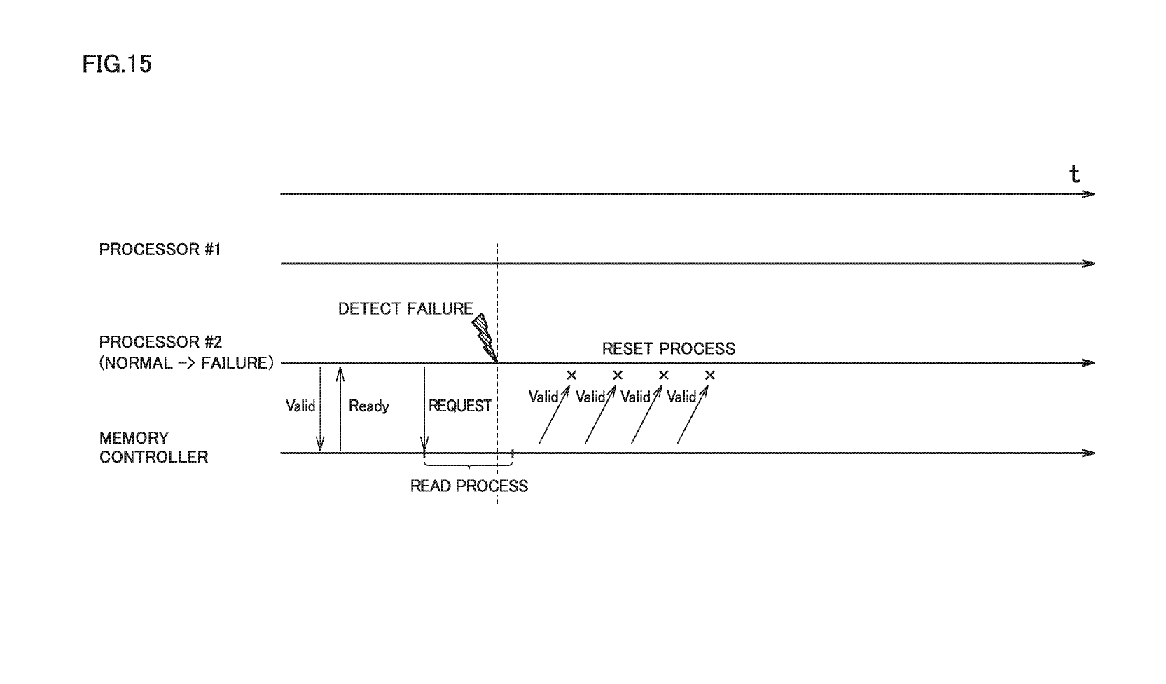

FIG. 15 is a diagram for illustrating a conventional operation example.

Master device MA1 is constituted of a processor #1. Master device MA2 is constituted of a processor #2. Slave device SL1 is constituted of a memory controller.

It is supposed that processor #1 and processor #2 are initially in a normal state. Processor #2 transmits the Valid signal indicating that it has a request to the memory controller, and the memory controller transmits the Ready signal to processor #2. After this, processor #2 transmits to the memory controller a read command as the request.

The memory controller starts a read process for reading data from a memory.

Before the memory controller transmits the read data as a response to processor #2, a failure occurs to processor #2. Processor #2 performs a reset process so as to return to the normal state.

After this, the memory controller transmits to processor #2 the Valid signal indicating that it has a response. However, processor #2 is performing the reset process. Therefore, processor #2 cannot receive the Valid signal. As a result, processor #2 cannot output the Ready signal.

Since the memory controller cannot receive the Ready signal from processor #2, the memory controller repeats transmission of the Valid signal. Accordingly, the whole operation of bus system 21 stops.

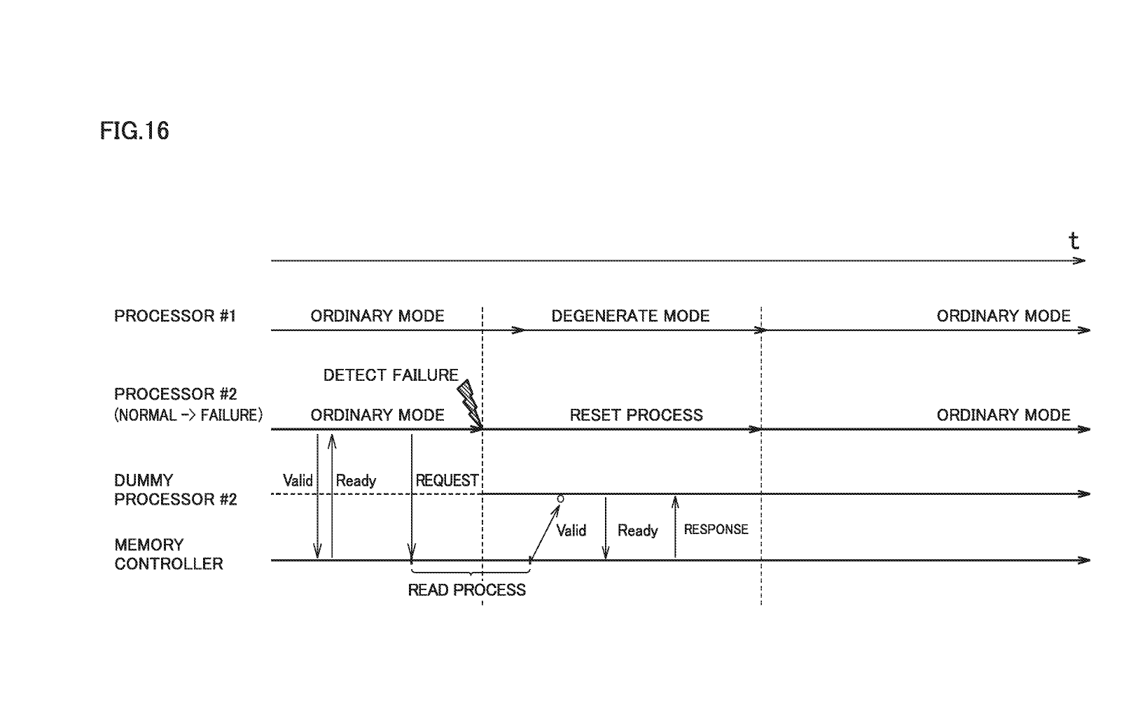

FIG. 16 is a diagram for illustrating a third operation example of bus system 21 in the third embodiment.

Master device MA1 is constituted of a processor #1. Master device MA2 is constituted of a processor #2. Slave device SL1 is constituted of a memory controller. A dummy processor #2 is provided correspondingly to master device MA2.

It is supposed that processor #1 and processor #2 are initially in a normal state. Processor #2 transmits the Valid signal indicating that it has a request to the memory controller, and the memory controller transmits the Ready signal to processor #2. After this, processor #2 transmits to the memory controller a read command as the request.

The memory controller starts a read process for reading data from a memory.

Before the memory controller transmits the read data as a response to processor #2, a failure occurs to processor #2. Processor #2 starts the reset process so as to return to the normal state.

After this, the memory controller transmits to processor #2 the Valid signal indicating that it has a response.

Since processor #2 is performing the reset process, processor #2 cannot receive the Valid signal. However, in place of processor #2, the dummy processor receives the Valid signal and outputs the Ready signal.

Receiving the Ready signal, the memory controller outputs a response. In this way, such a situation where the memory controller continues transmitting the Valid signal can be avoided. Even when the memory controller thereafter receives a request from processor #1, a response can be made to the request.

As described above, according to the present embodiment, after any master device or slave device transmits the signal indicating that valid data is present to a device to which a failure occurs, the master device or slave device can receive the signal indicating that signal reception is possible. As a result, processing of the whole system is prevented from stagnating.

### Fourth Embodiment

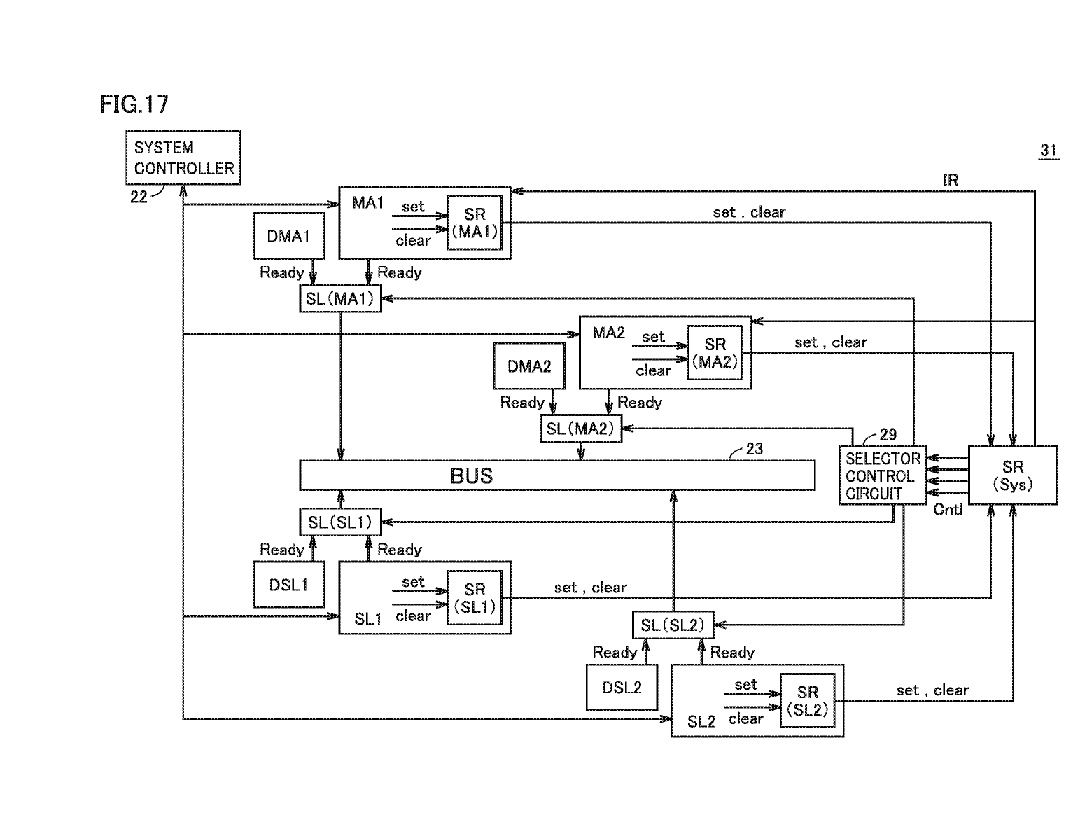

FIG. 17 is a diagram showing a configuration of a bus system 31 in a fourth embodiment.

This bus system 31 is different from bus system 21 of the third embodiment in the following points.

Master device MA1 includes master status register SR (MA1). Master device MA2 includes master status register SR (MA2). Slave device SL1 includes slave status register SR (SL1). Slave device SL2 includes slave status register SR (SL2).

According to the present embodiment, the master device and the slave device each including the status register can be provided as an IP (intellectual property) core which has a reset function and a dummy switching function.

### Fifth Embodiment

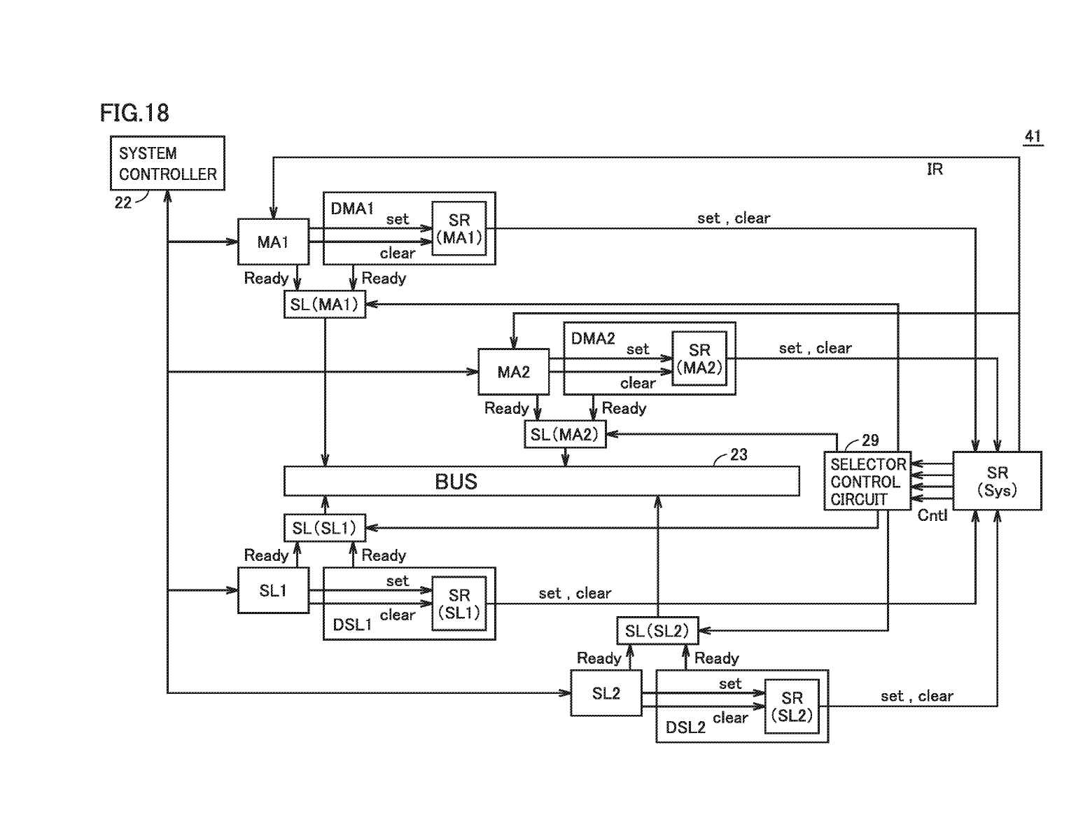

FIG. 18 is a diagram showing a configuration of a bus system 41 in a fifth embodiment.

This bus system 41 is different from bus system 21 of the third embodiment in the following points.

Dummy master device DMA1 includes master status register SR (MA1). Dummy master device DMA2 includes master status register SR (MA2). Dummy slave device DSL1 includes slave status register SR (SL1). Dummy slave device DSL2 includes slave status register SR (SL2).

In the present embodiment, the dummy master device and the dummy slave device each including the status register can be added to the bus system to reduce as much as possible changes of the configuration of the other components of the conventional bus system.

### Sixth Embodiment

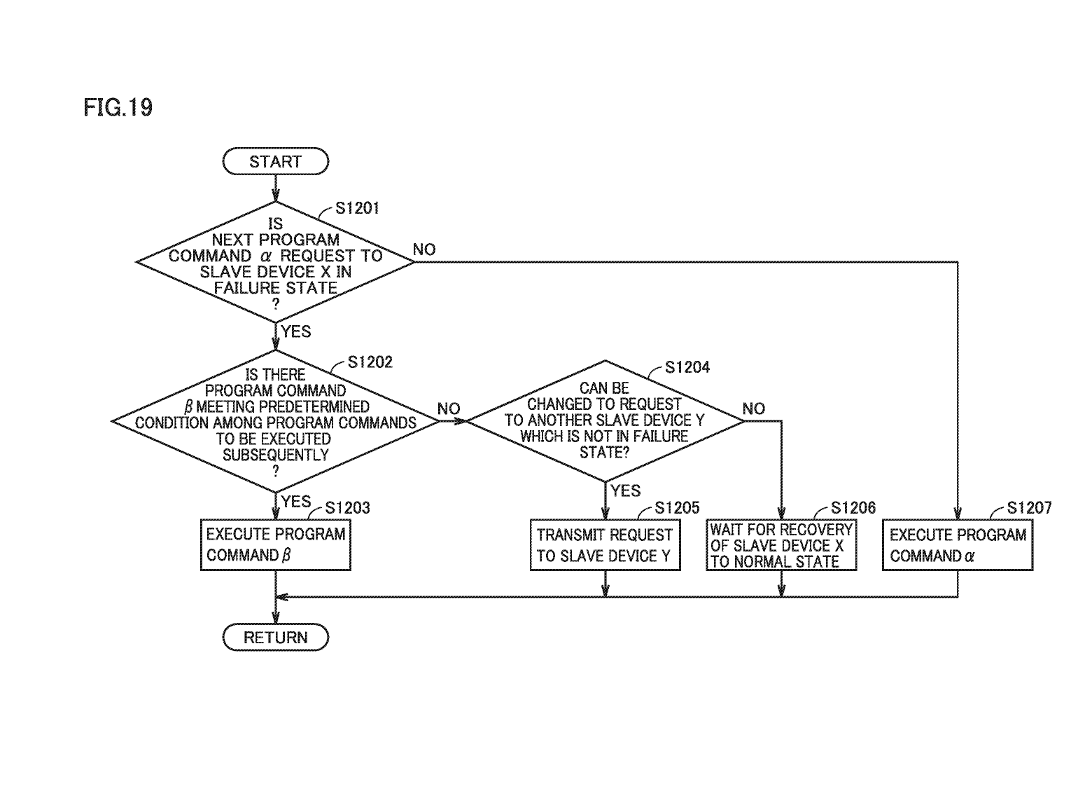

FIG. 19 is a flowchart showing an operational procedure of master device MA1 in the degenerate mode. An operational procedure of master device MA2 in the degenerate mode is similar to this.

In step S1201, when a program command α to be executed next includes a request to a slave device X which is in a failure state, the process proceeds to step S1202. When program command α to be executed next does not include a request to slave device X which is in a failure state, the process proceeds to step S1207.

In step S1202, when there is a program command β which meets a predetermined condition among a plurality of program commands to be executed subsequently to program command α, the process proceeds to step S1203. When there is no such a program command α, the process proceeds to step S1204. The program command which meets a predetermined condition is a program command which does not produce an adverse effect even when the program command is executed before program command α.

In step S1204, in the case where a request which is included in program command α and which is a request to slave device X can be changed to a request to any slave device other than slave device X, the process proceeds to step S1205. The aforementioned case where this change can be made is such a case for example where it is necessary to write certain data temporarily in a memory and a request to write to memory A can be changed to a request to write to memory B. When such a change is impossible, the process proceeds to step S1206.

In step S1203, master device MA1 executes program command β.

In step S1205, master device MA1 transmits a request to a slave device Y to thereby execute program command α in an alternative manner.

In step S1206, master device MA1 waits for return-to-normal of slave device X.

In step S1207, master device MA1 transmits a request to slave device X to thereby execute program command α.

As described above, according to the present embodiment, the master device in the degenerate mode executes a command other than a command which should originally be executed, or makes an access to a slave device instead of an access which should originally be made to a slave device in a failure state. A process can be prevented from being caused for the slave device in the failure state.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A bus system comprising:
a bus;
a plurality of master devices connectable to the bus;
one or more slave devices connectable to the bus;
a first dummy master device connectable to the bus,
when the first dummy master device receives a signal indicating that valid data is present, in place of a first master device which is included in the plurality of master devices, the first dummy master device outputting a signal indicating that signal reception is possible;
a selector configured to connect one of the first master device and the first dummy master device to the bus;
a system controller configured to cause a reset process to be performed by only a master device which is included in the plurality of master devices and to which a failure occurs, so as to cause the master device to which the failure occurs to return to a normal state; and
a selector control circuit configured to control the selector to connect the first dummy master device to the bus when the first master device is in a failure state.

2. The bus system according to claim 1, wherein
while the reset process of the first master device is performed upon occurrence of a failure to the first master device, master devices except for the first master device among the plurality of master devices shift to a degenerate mode, and
in the degenerate mode, the master devices except for the first master device regulate respective processes of the master devices so as not to cause a process for the first master device.

3. The bus system according to claim 1, further comprising a first register, wherein
the first master device sets the first register when the failure occurs, and clears the first register when the reset process is completed.

4. The bus system according to claim 3, wherein the first register is provided in the first master device.

5. The bus system according to claim 3, wherein the first register is provided in the first dummy master device.

6. The bus system according to claim 1, wherein the selector control circuit is configured to control the selector to connect the first master device to the bus after the reset process of the first master device is completed.

7. A bus system comprising:
a bus;
one or more master devices connectable to the bus;
a plurality of slave devices connectable to the bus;
a first dummy slave device connectable to the bus,
when the first dummy slave device receives a signal indicating that valid data is present, in place of a first slave device which is included in the plurality of slave devices, the first dummy slave device outputting a signal indicating that signal reception is possible;
a selector configured to connect one of the first slave device and the first dummy slave device to the bus;
a system controller configured to cause a reset process to be performed by only a slave device which is included in the plurality of slave devices and to which a failure occurs, so as to cause the slave device to which the failure occurs to return to a normal state; and
a selector control circuit configured to control the selector to connect the first dummy slave device to the bus when the first slave device is in a failure state.

8. The bus system according to claim 7, wherein
while the reset process of the first slave device is performed upon occurrence of a failure to the first slave device, the one or more master devices shift to a degenerate mode, and
in the degenerate mode, the one or more master devices regulate respective processes of the one or more master devices so as not to cause a process for the first slave device.

9. The bus system according to claim 7, further comprising a first register, wherein
the first slave device sets the first register when the failure occurs, and clears the first register when the reset process is completed.

10. The bus system according to claim 9, wherein the first register is provided in the first slave device.

11. The bus system according to claim 9, wherein the first register is provided in the first dummy slave device.

12. The bus system according to claim 7, wherein the selector control circuit is configured to control the selector to connect the first slave device to the bus after the reset process of the first slave device is completed.

13. A bus system comprising:
a bus;
a plurality of master devices connectable to the bus;
a plurality of slave devices connectable to the bus;
a plurality of dummy master devices each provided in association with a corresponding one of the master devices,
when the plurality of dummy master devices each receive a signal indicating that valid data is present, in place of the corresponding one of the master devices, the plurality of dummy master devices each outputting a signal indicating that signal reception is possible;
a plurality of dummy slave devices each provided in association with a corresponding one of the slave devices,
when the plurality of dummy slave devices each receive a signal indicating that valid data is present, in place of the corresponding one of the slave devices, the plurality of dummy slave devices each outputting a signal indicating that signal reception is possible;
a plurality of selectors each configured to connect, to the bus, one of
a corresponding one of the master devices and the slave devices, and
a corresponding one of the dummy master devices and the dummy slave devices;
a system controller configured to cause a reset process to be performed by only a device which is one of the plurality of master devices and the plurality of slave devices and to which a failure occurs, so as to cause the device to which the failure occurs to return to a normal state; and
a selector control circuit configured to control, when a device which is one of the plurality of master devices and the plurality of slave devices is in a failure state, the selector corresponding to the device which is in the failure state, so as to connect, to the bus, a corresponding one of the dummy master devices or a corresponding one of the dummy slave devices.

14. The bus system according to claim 13, further comprising:
a plurality of first-type registers each provided in association with a corresponding one of the plurality of master devices and the plurality of slave devices; and
a second-type register provided to identify whether the plurality of master devices and the plurality of slave devices are each in a normal state or a failure state, wherein
the master devices and the slave devices are each configured to set a corresponding first-type register, which is a corresponding one of the first-type registers, when a failure occurs, and to clear the corresponding first-type register when the reset process is completed,
when the first-type register is set, the first-type register sets a bit which is in the second-type register and which corresponds to the first-type register and, when the first-type register is cleared, the first-type register clears the bit which is in the second-type register and which corresponds to the first-type register,
when a bit value held in the second-type register is changed, the second-type register outputs an interrupt signal to the plurality of master devices, and
the selector control circuit is configured to control the plurality of selectors based on the bit value held in the second-type register.
